(19) United States
(12) Patent Application Publication
(10) Pub. No.: US 2013/0239531 A1
(43) Pub. Date: Sep. 19, 2013

(54) AIR CLEANER

(71) Applicant: Yoshitaka Koda, Hamamatsu-shi (JP)

(72) Inventor: Yoshitaka Koda, Hamamatsu-shi (JP)

(21) Appl. No.: 13/884,121

(22) PCT Filed: Nov. 16, 2011
(86) PCT No.: PCT/JP2011/076356

§ 371 Date: May 8, 2013

(30) Foreign Application Priority Data
Nov. 18, 2010 (JP) 2010-258178

(51) Int. Cl. B01D 46/00

(52) U.S. Cl. CPC B01D 46/0005
USPC 55/502

(57) ABSTRACT

An air cleaner reliably seals hermetically without reducing capacity and increasing size. In the air cleaner including a housing constituted of a case in which an opening and an inlet port are formed, and a cover that has an outlet port formed, and hermetically seals the opening, and including a filter element that partitions an inside of the housing into a dust side on a side of the inlet port, and a clean side on a side of the outlet port, the filter element including a filter portion that filters a fluid flowing from the inlet port, and a flange portion having a seal device that hermetically seals the opening along the opening and is formed by being extended toward an outer side of the housing, a seal device protection portion extending along an extending direction of the flange portion is further formed on the flange portion.

### TECHNICAL FIELD

The present invention relates to an air cleaner and, more particularly, to an air cleaner that prevents a seal device that hermetically seals the inside of the air cleaner from being damaged or being turned up and assembled at the time of assembly of a filter element, and enables assembly of the filter element to an accurate position in an accurate state.

### BACKGROUND ART

Conventionally, as an air cleaner for an internal combustion engine, there has been known such an air cleaner in which a case and a cover are connected to each other by a hinge structure configured by a hinge and a hinge receiving portion, and the case and the cover are formed to be openable and closable by being rotated with respect to each other. In such an air cleaner, an intake port is formed in one of the case and the cover, whereas an exhaust port is formed in the other one, and a filter element is housed in the inside thereof with an outer edge of the filter element sandwiched by the case and the cover so that the intake port and the exhaust port communicate with each other via the filter element.

Further, the air cleaner has the function of filtering out dust and the like included in external air taken in from the intake port, and supplying the filtered external air to an internal combustion engine side from the exhaust port, and therefore, the inside of the air cleaner is hermetically sealed so as not to communicate with an outside. As the structure of the hermetical sealing, various structures are known, and, as described in, for example, Patent Literature 1, there is known a method for hermetically sealing the inside of the air cleaner by providing the seal device at the outer edge of the filter element, and sandwiching the seal device with the case and the cover.

### CITATION LIST

### Patent Literature

Patent Literature 1: Japanese Patent Laid-Open No. 2005-36701

The air cleaner described in Patent Literature 1 realizes hermetical sealing of the air cleaner by the packing, which is formed on the outer edge of the filter element, being housed in the top surface of the case in such a manner as to be sandwiched between the peripheral edge of the cover and the peripheral edge of the case. Further, a filter element is a member requiring regular replacement, and therefore, when the replacement operation of the filter element is performed in a state in which the air cleaner is assembled to a vehicle body, the packing slides with respect to the opening, whereby the packing is damaged or turned up and assembled, and is likely to degrade sealing performance. In order to prevent this, the air cleaner includes a case 120 having an opening, a cover that opens and closes the opening of the case 120, and a filter element 130 that has a packing 133 attached to a peripheral edge, and is housed in the aforementioned case 120 by being inserted from the opening of the aforementioned case 120, and includes the configuration in which inside the aforementioned case 120, a guide 121 that supports a distal end side in the insertion direction of the filter element 130 from below halfway through insertion of the aforementioned filter element 130, and guides the aforementioned filter element 130 to avoid contact of the aforementioned packing 133 and the opening of the aforementioned case 120, as shown in FIG. 10. Further, as another method for preventing a packing from being damaged or turned up, there is known a method for preventing a packing 133′ from being damaged or turned up by disposing the packing 133′ at a lower side, which slides with a seal surface 125 of the case 120 at the time of assembly of a filter element 130′, in an opposite orientation from a packing 133 at an upper side, as shown in FIG. 11.

As above, the air cleaner described in Patent Literature 1 hermetically seals the inside of the air cleaner by sandwiching the filter element with the case and the cover, and prevents the packing from being damaged or turned up by providing the guide inside the case and adjusting the shape of the packing.

### SUMMARY OF INVENTION

### Technical Problem

According to the configuration of the conventional air cleaner described above, the air cleaner described in Patent Literature 1 has the guide 121 formed in the case 120 as the method for preventing the packing from being damaged or turned up, and therefore, has the problem that the capacity of the inside of the case 120 decreases and the case 120 increases in size in order to ensure the capacity of the air cleaner. Further, in the case 120 to be the channel of a fluid, the guide 121 is formed, and therefore, there is the possibility of inhibiting smooth ventilation. Further, according to the method for preventing the packing from being damaged and turned up illustrated as in FIG. 11, the packing 133′ at the lower side is disposed in the opposite orientation from the packing 133 at the upper side, and therefore, there is the problem of significantly reducing the sealing performance in the direction toward the inside from the outside of the air cleaner, and being unable to ensure the performance of the air cleaner.

Thus, the present invention is made in the light of the above described problems, and has an object to provide an air cleaner that can reliably seal the air cleaner hermetically without causing reduction in the capacity of the air cleaner and increase in the size of the air cleaner.

### Solution to Problem

An air cleaner according to the present invention is an air cleaner including a housing constituted of a case in which an opening and an inlet port are formed, and a cover that has an outlet port formed, and hermetically seals the opening, and including a filter element that partitions an inside of the housing into a dust side on a side of the inlet port, and a clean side on a side of the outlet port, the filter element including a filter portion that filters a fluid flowing from the inlet port, and a flange portion having a seal device that hermetically seals the opening along the opening and is formed by being extended toward an outer side of the housing, wherein the flange portion further includes a seal device protection portion extending along an extending direction of the flange portion.

Further, in the air cleaner according to the present invention, the seal device protection portion is preferably extended along an insertion direction at a time of assembling the filter element to the housing.

Further, in the air cleaner according to the present invention, the seal device protection portion is preferably inserted into a cutout portion formed on the case.

Further, in the air cleaner according to the present invention, the seal device protection portion preferably protrudes to an outside of the case.

Further, in the air cleaner according to the present invention, the seal device protection portion preferably includes, at a distal end portion, a protruding portion that protrudes to a side of the case.

Further, in the air cleaner according to the present invention, the seal device protection portion is preferably formed integrally with the seal device.

Further, in the air cleaner according to the present invention, two or more of the seal device protection portions are preferably formed.

The outline of the above described invention is not the list of all the necessary features of the present invention, and the sub combination of the feature groups also can be the invention.

### Advantageous Effects of Invention

The air cleaner according to the present invention includes a seal device protection portion extending along an extending direction of the flange portion at the filter element, and therefore, the filter element can be reliably installed into the housing without reducing the capacity of the case, and without causing damage and turning up of the seal device.

Further, in the air cleaner according to the present invention, the seal device protection portion is extended along an insertion direction at a time of assembling the filter element to the housing. Therefore, the seal device does not contact the opening at the time of assembly of the filter element, damage and turning-up of the seal device is prevented, the seal device can be assembled in the correct attitude, and the air cleaner can be reliably sealed hermetically.

Further, in the air cleaner according to the present invention, the seal device protection portion is inserted into the cutout portion formed on the case, and therefore, when the filter element is inserted with an erroneous orientation of the filter element, erroneous assembly of the filter element can be prevented.

Further, in the air cleaner according to the present invention, the seal device protection portion protrudes to an outside of the case. Therefore, it can be visually confirmed from the outside of the air cleaner that the filter element is assembled, and omission of assembly of the filter element can be prevented.

Further, in the air cleaner according to the present invention, the seal device protection portion includes the protruding portion that protrudes to a side of the case. Therefore, the protruding portion slides with the case at the time of assembly of the filter element, and the seal device and the case can be prevented from contacting each other.

Further, in the air cleaner according to the present invention, the seal device protection portion is formed integrally with the seal device. Therefore, by integral molding, the seal device protection portion can be easily formed, and the manufacture cost can be suppressed.

Further, in the air cleaner according to the present invention, two or more of the seal device protection portions are formed. Therefore, the filter element can be prevented from being inserted by being diagonally inclined, the seal device does not contact the opening at the time of assembly of the filter element, damage and turning-up of the seal device are prevented, the seal device can be assembled in the correct attitude, and the air cleaner can be reliably sealed hermetically.

### BRIEF DESCRIPTION OF DRAWINGS

FIG. 1 is a front view for explaining an outline of an air cleaner according to a first embodiment.

FIG. 2 is a front view for explaining a configuration of the air cleaner according to the first embodiment.

FIG. 3 is a front view for explaining a configuration of a filter element which is assembled to the air cleaner according to the first embodiment.

FIG. 4 is an enlarged view for explaining a configuration of a seal device protection portion.

FIG. 5 is an enlarged perspective view for explaining a cutout portion of a case.

FIG. 6 is an enlarged perspective view for explaining an assembled state of the filter element.

FIG. 7(a) is a view for explaining a procedure of assembling the filter element to the air cleaner according to the first embodiment.

FIG. 7(b) is a view for explaining the procedure of assembling the filter element to the air cleaner according to the first embodiment.

FIG. 7(c) is a view for explaining the procedure of assembling the filter element to the air cleaner according to the first embodiment.

FIG. 8(a) is a view for explaining a procedure of assembling a filter element to an air cleaner according to a second embodiment.

FIG. 8(b) is a view for explaining the procedure of assembling the filter element to the air cleaner according to the second embodiment.

FIG. 8(c) is a view for explaining the procedure of assembling the filter element to the air cleaner according to the second embodiment.

FIG. 9 is a front view for explaining a configuration of a filter element which is assembled to an air cleaner according to a third embodiment.

FIG. 10 is a sectional view for explaining a structure of a conventional air cleaner.

FIG. 11 is a sectional view for explaining another structure of the conventional air cleaner.

### DESCRIPTION OF EMBODIMENTS

Hereinafter, preferred embodiments for carrying out the present invention will be described with use of the drawings. Note that the following embodiments are not intended to limit the invention according to each of the claims, and all of combinations of the features described in the embodiments are not necessarily essential to the solution of the invention.

### First Embodiment

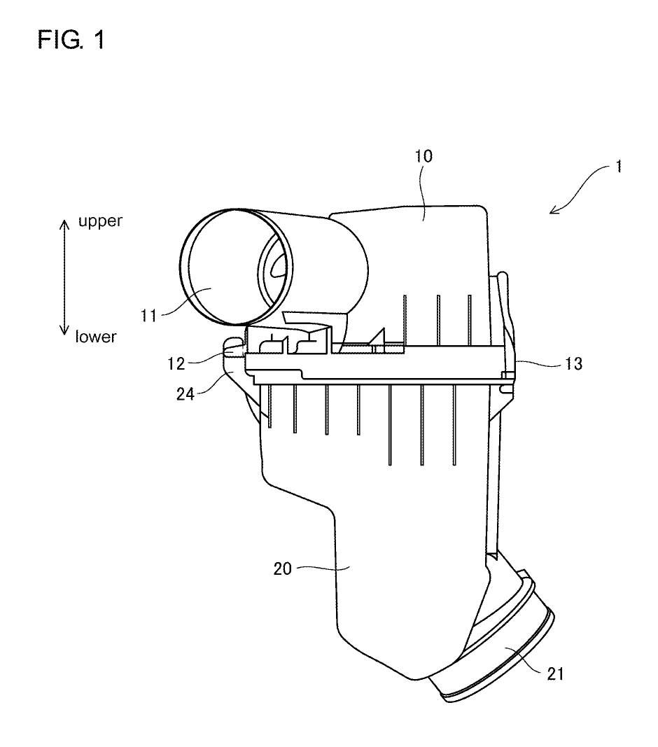

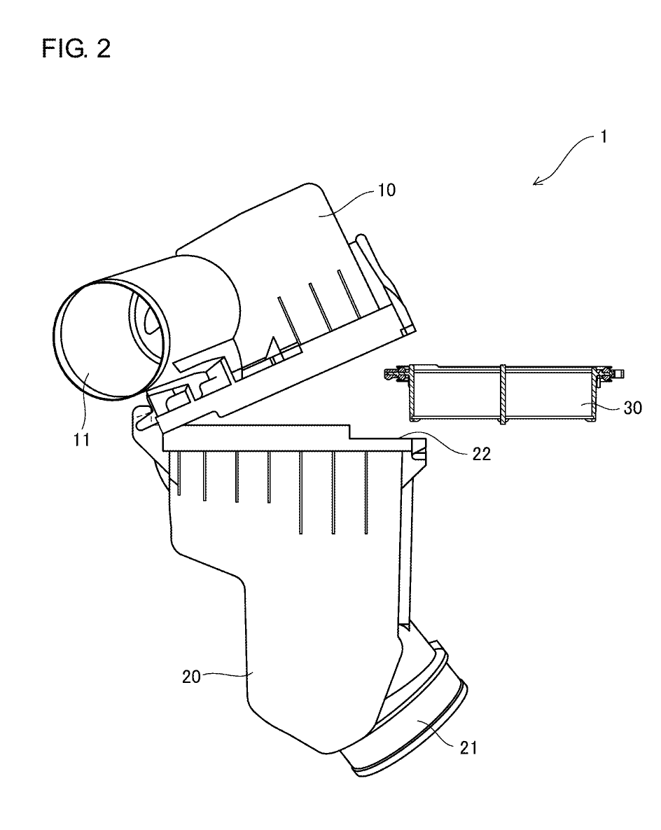

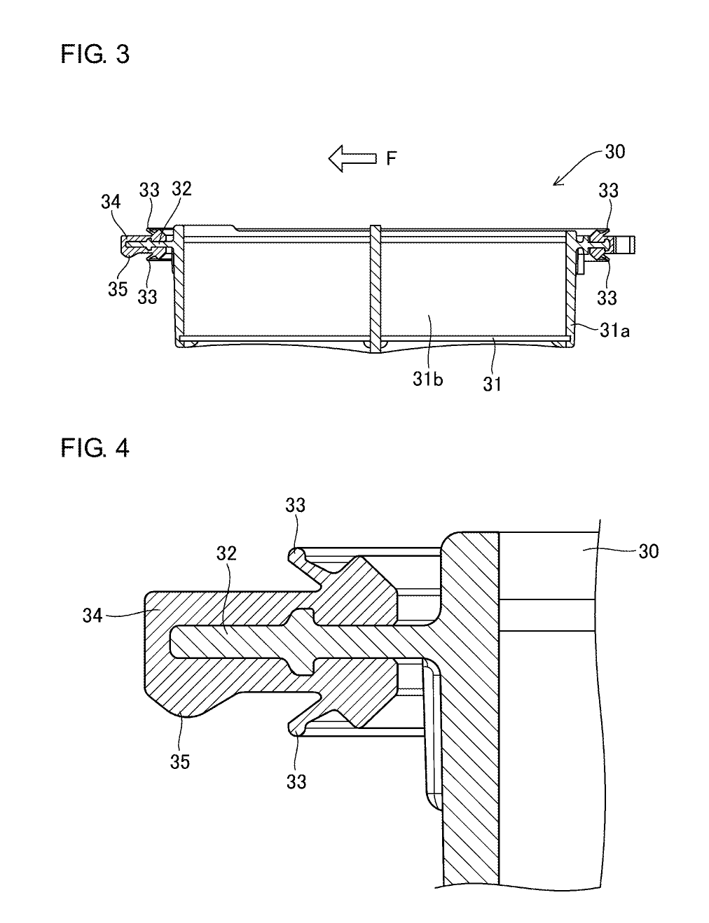

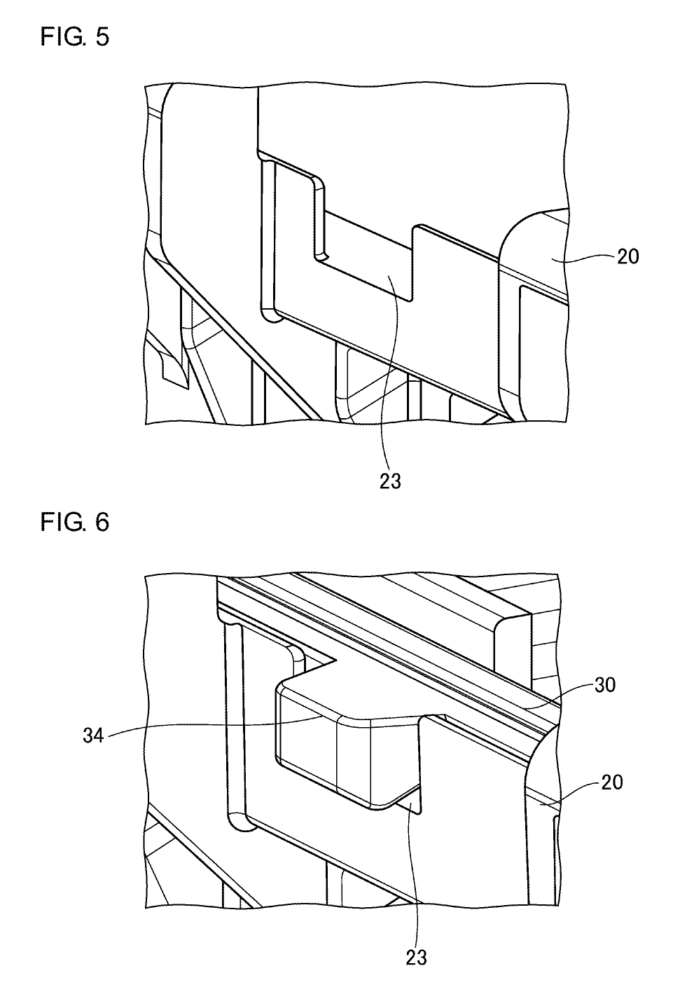

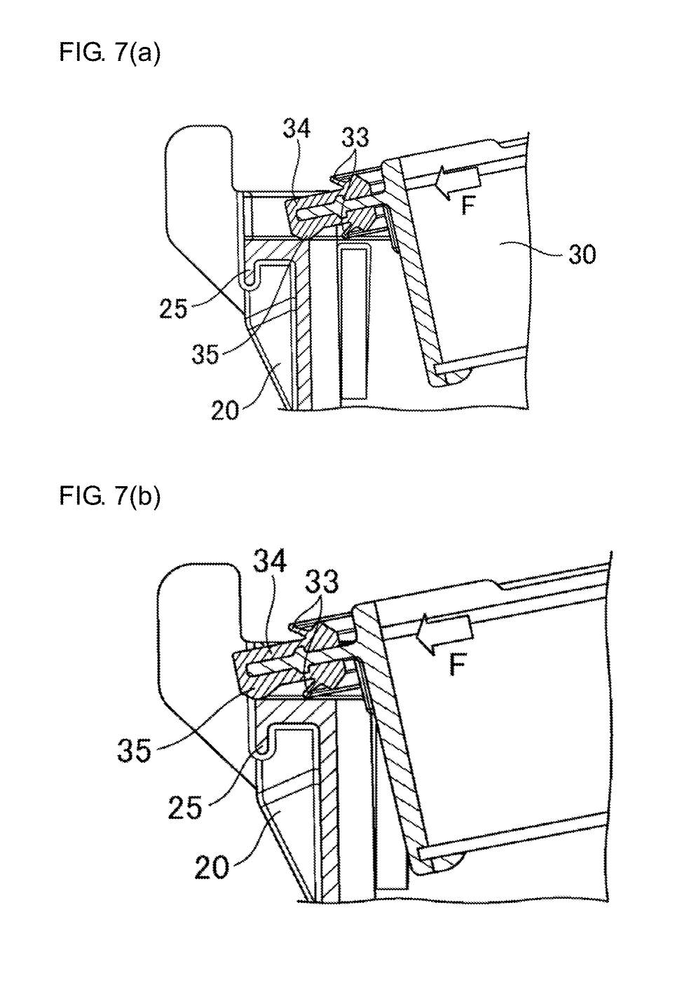

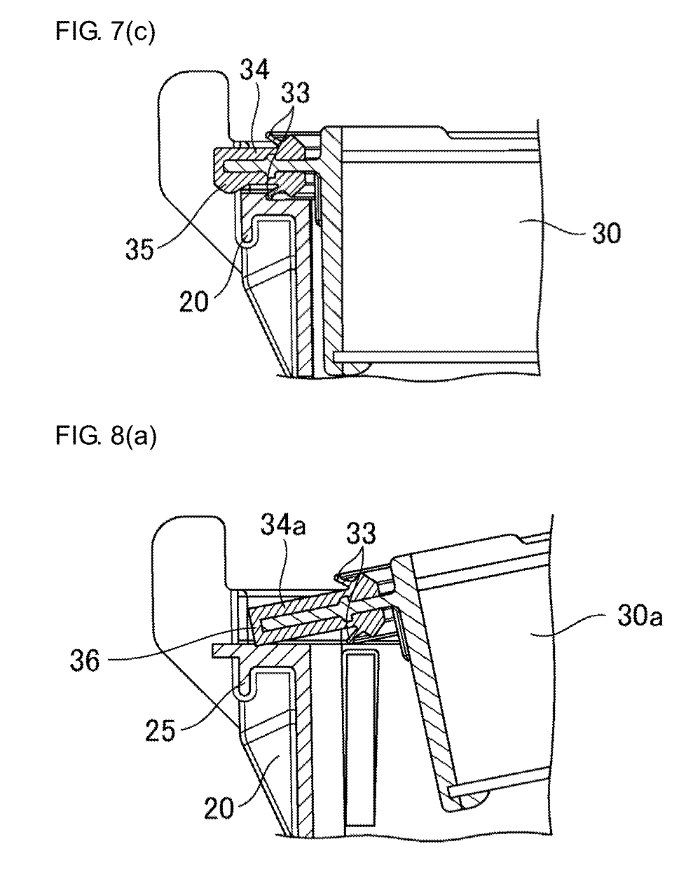

FIG. 1 is a front view for explaining an outline of an air cleaner according to a first embodiment, FIG. 2 is a front view for explaining a configuration of the air cleaner according to the first embodiment, FIG. 3 is a front view for explaining a configuration of a filter element which is assembled to the air cleaner according to the first embodiment, FIG. 4 is an enlarged view for explaining a configuration of a seal device protection section, FIG. 5 is an enlarged perspective view for explaining a cutout portion of a case, FIG. 6 is an enlarged perspective view for explaining an assembled state of the filter element, FIGS. 7(a) to (c) are views for explaining a procedure of assembling the filter element to the air cleaner according to the first embodiment. Note that the directions illustrated as the arrows in FIG. 1 are defined as an upper and a lower directions.

As shown in FIG. 1 and FIG. 2, an air cleaner 1 according to the present embodiment is configured by including a housing constituted of a case 20 and a cover 10 which closes an opening 22 of the case 20, and by a filter element 30 interposed between the case 20 and the cover 10.

The case 20 is formed into a bottomed cylindrical shape having the opening 22, and an inlet port 21 from which an intake fluid such as external air is introduced is formed.

The cover 10 is assembled to close the opening 22 of the case 20, as described above, and an outlet port 11 from which the intake fluid is discharged to an internal combustion engine side is formed. Note that the cover 10 is detachably assembled to the case 20 by a hinge portion 12 formed on the cover 10 being engaged with a hinge receiving portion 24 formed on the case 20. Further, the case 20 and the cover 10 are assembled by a latch portion 13 in a state in which the cover 10 closes the opening 22 of the case 20. For the latch portion 13, a known latch device such as a clip and snap fit can be applied other than fastening by a bolt and a nut. Note that the case 20 and the cover 10 are formed by a thermoplastic synthetic resin such as a polypropylene resin and a polyamide resin.

As shown in FIG. 3, the filter element 30 includes a filter portion 31 which filters the intake fluid flowing in from the inlet port 21, and a flange portion 32 that is mounted with seal devices 33 that hermetically seal the opening 22 along the opening 22, and is formed by being extended toward an outer side of the housing. The filter element 30 provides partition between a dust side that communicates with the inlet port 21, and a clean side that communicates with the outlet port 11, and hermetically seals the inside of the housing by being sandwiched by the case 20 and the cover 10 by the seal device 33 being placed on a seal surface 25 formed along the peripheral edge of the opening 22 of the aforementioned case 20, and the cover 10 being assembled from above the seal device 33.

The filter portion 31 is constituted of a filter material 31b formed by pleating unwoven fabric, filter paper or the like, and a frame 31a that holds the filter material 31b, and pleating is applied to the filter material 31b, whereby increase in a filter area and suppression of ventilation resistance are achieved. Note that the filter material 31b can also be configured as a planar sheet without applying pleating.

The flange portion 32 is formed to be extended toward the outer side of the housing from the frame 31a to be along the seal surface 25, and the seal devices 33 are mounted on a top and a bottom surfaces thereof. The seal devices 33 are formed into tongue shapes which protrude in diagonally upper and lower directions toward the case 20 and the cover 10 from the flange portion 32. The seal devices 33 are formed of a material having an elastic force such as rubber and elastomer, and the seal devices 33 are deformed by being sandwiched by the case 20 and the cover 10, and thereby, seal against the intake fluid passing through the inside of the air cleaner 1. As above, the filter element 30 partitions the inside of the air cleaner 1 into a dust side on a side communicating with the inlet port 21, and a clean side on a side communicating with the outlet port 11. Note that the extending direction of the flange portion 32 is formed to be substantially horizontal with an insertion direction F of the filter element 30.

As shown in FIG. 4, a seal device protection portion 34 extending along the insertion direction F of the filter element 30 from the distal end of the flange portion 32 is mounted on the flange portion 32. At the seal device protection portion 34, a protruding portion 35 that protrudes toward a side of the seal surface 25 that is formed at the opening 22 of the case 20. Further, as shown in FIG. 5 and FIG. 6, the filter element 30 is assembled by the seal device protection portion 34 being inserted into the cutout portion 23 formed at the opening 22 of the case 20. In the state in which the filter element 30 is assembled to the case 20, the seal device protection portion 34 is assembled by protruding to the outside of the case 20. Note that the seal device protection portion 34 and the protruding portion 35 are formed integrally with the seal devices 33.

Next, with reference to FIGS. 7(a) to (c), an assembling method of the filter element 30 of the air cleaner 1 according to the present embodiment will be described. Note that in FIGS. 7(a) to (c), illustration of the cover 10 which closes the case 20 is omitted, but since a plurality of components are disposed around the internal combustion engine, the cover 10 cannot be removed from the case 20 at the time of a replacement operation of the filter element 30, and therefore, the assembling operation of the filter element 30 needs to be performed in the state in which the opening 22 cannot be sufficiently opened.

As illustrated in FIG. 7(a), the filter element 30 is inserted along the insertion direction F from diagonally above the opening 22 of the case 20. When the filter element 30 is inserted, the protruding portion 35 which protrudes to the case 20 side abuts on the seal surface 25 of the opening 22, in the seal device protection portion 34 formed on the distal end of the flange portion 32.

When the filter element 30 is further inserted along the insertion direction F in the state in which the protruding portion 35 abuts on the seal surface 25, the protruding portion 35 slides along the seal surface 25 as illustrated in FIG. 7(b). Since the protruding portion 35 is formed on the seal device protection portion 34 as above, the seal device 33 does not touch the seal surface 25 when the protruding portion 35 slides along the seal surface 25, and damage and turning-up of the seal device 33 can be prevented.

Furthermore, the air cleaner 1 according to the present embodiment can ensure the capacity of the air cleaner, and can suppress increase in the size of the air cleaner while keeping the performance, because a guide does not have to be formed in the inside of the case 20.

Note that as illustrated in FIG. 7(c), in the state in which the filter element 30 is assembled to the case 20, the protruding portion 35 separates from the seal surface 25 and protrudes to the outside of the case 20, and therefore, the protruding portion 35 does not inhibit hermetical sealing of the seal device 33.

Further, since the seal device protection portion 34 protrudes to the outside of the case 20, it can be visually confirmed that the filter element 30 is assembled, from the outside of the air cleaner 1 after the replacement operation of the filter element 30 is finished, and it can be confirmed that the filter element 30 is reliably assembled by the replacement operation.

Further, the seal device protection portion 34 is inserted into the cutout portion 23 which is formed at the opening 22 of the case 20, and therefore, the filter element 30 can be prevented from being assembled inside out.

The air cleaner according to the first embodiment is described above. However, the air cleaner according to the present invention is not limited to the above mode. Thus, an air cleaner having another mode will be described next.

### Second Embodiment

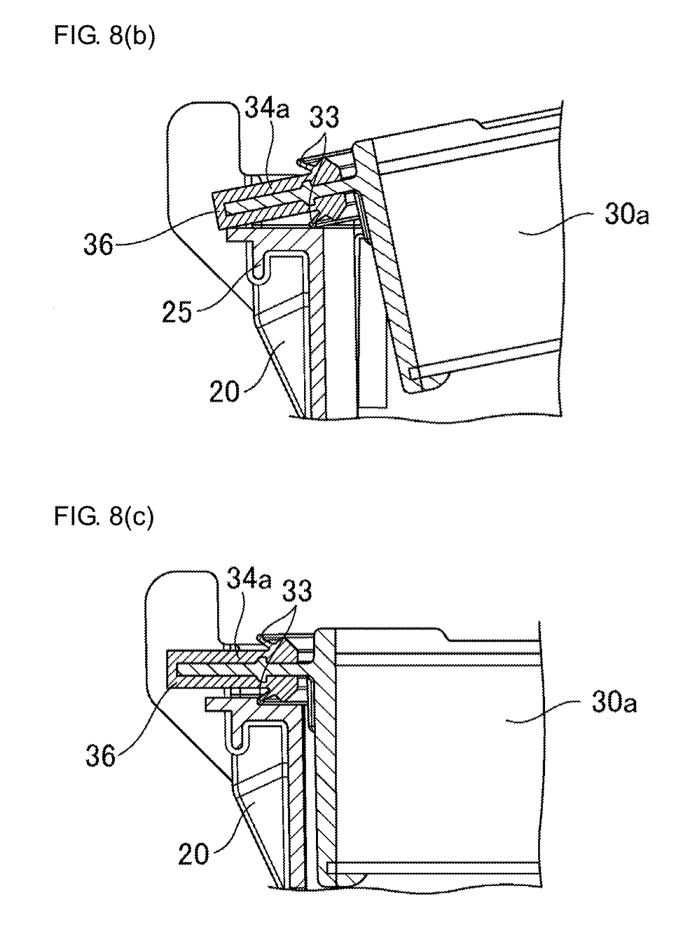

FIGS. 8(a) to (c) are views for explaining a procedure of assembling a filter element to an air cleaner according to a second embodiment. In the air cleaner according to the second embodiment described as follows, the same or the similar members as or to the air cleaner according to the first embodiment described above will be assigned with the same reference signs and the description thereof will be omitted in some cases.

As shown in FIG. 8(a), the air cleaner according to the present embodiment is formed substantially similarly to the air cleaner according to the first embodiment described above, and the characteristic point is the point in which the shape of a seal device protection portion 34a includes an extended portion 36 which is formed by the seal device protection portion 34 further being extended along the insertion direction F.

In the air cleaner according to the present embodiment formed in this manner, a filter element 30a is inserted along the insertion direction F from diagonally above the opening 22 of the case 20, as illustrated in FIG. 8(a), at the time of a replacement operation of the filter element 30a. When the filter element 30a is inserted, in the seal device protection portion 34a which is formed on a distal end of the flange portion 32, the extended portion 36 which is further extended from a distal end thereof abuts on the seal surface 25 of the opening 22.

When the filter element 30a is further inserted along the insertion direction F in the state in which the extended portion 36 abuts on the seal surface 25, the extended portion slides along the seal surface 25 as illustrated in FIG. 8(b). Since the extended portion 36 is formed on the seal device protection portion 34a like this, the seal device 33 does not touch the seal surface 25 when the extended portion 36 slides along the seal surface 25, and damage and turning-up of the seal device 33 can be prevented.

Note that in the state in which the filter element 30a is assembled to the case 20, the extended portion 36 separates from the seal surface 25 and protrudes to the outside of the case 20 as illustrated in FIG. 8(c), and therefore, the extended portion 36 does not inhibit hermetical sealing of the seal device 33.

The air cleaner according to the second embodiment is described above. However, the air cleaner according to the present invention is not limited to this mode. Thus, an air cleaner having another mode will be described next.

### Third Embodiment

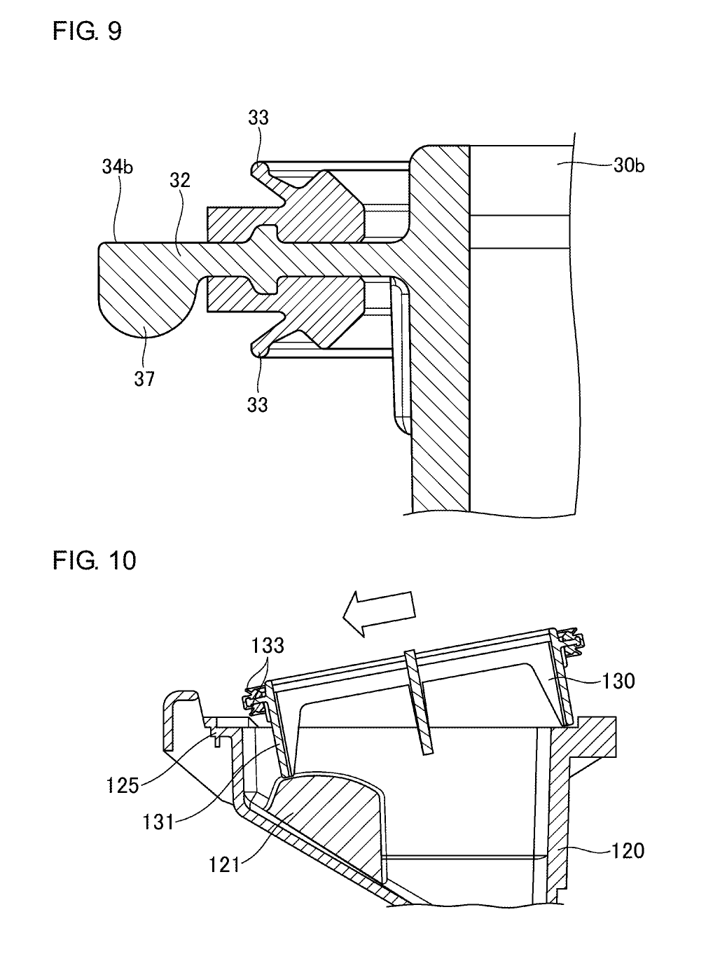

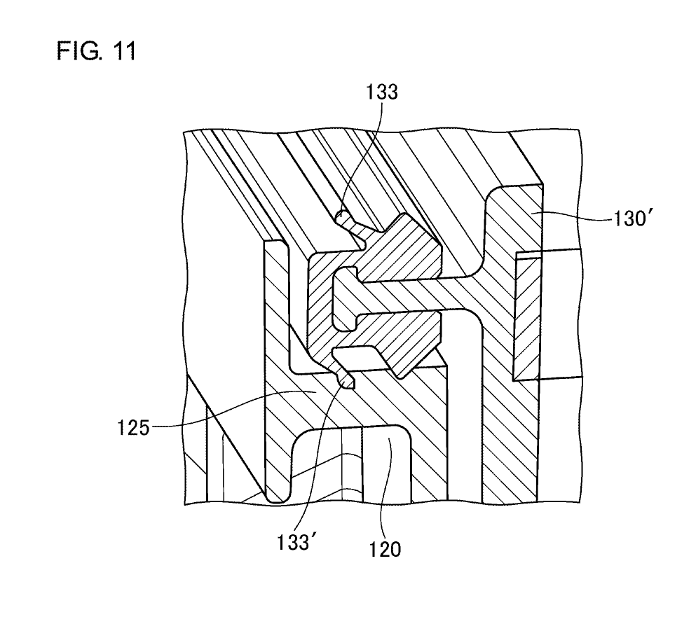

FIG. 9 is a front view for explaining a configuration of a filter element which is assembled to an air cleaner according to a third embodiment. Note that in the air cleaner according to the third embodiment described as follows, members which are the same as or similar to the air cleaners according to the first and the second embodiments described above will be assigned with the same reference signs, and the description thereof will be omitted in some cases.

As shown in FIG. 9, the air cleaner according to the present embodiment is formed substantially similarly to the air cleaner according to the first embodiment described above, and a characteristic point is the point in which a seal device protection portion 34b is formed integrally with the flange portion 32 of a filter element 30b. Namely, in the filter element 30b used in the air cleaner according to the present embodiment, the flange portion 32 is formed by being extended along the seal surface from the element portion 31, and the seal devices 33 are mounted on a top and a bottom surfaces thereof.

Further, the flange portion 32 protrudes from the seal devices 33 toward the extending direction of the flange portion 32 to form the seal device protection portion 34b. Furthermore, at the seal device protection portion 34b, a protruding portion 37 that protrudes toward the side of the seal surface 25 which is formed at the opening 22 of the case 20.

Since in the air cleaner according to the present embodiment, the seal device protection portion 34b is formed integrally with the flange portion 32 as above, the seal device 33 does not touch the seal surface 25, and damage and turning-up of the seal device 33 can be prevented, when the seal device protection portion 34b slides along the seal surface 25 formed on the case 20 when the filter element 30b is assembled. Further, since the flange portion 32 and the case 20 are both formed of a synthetic resin, the slide resistance at the time of the seal device protection portion 34b sliding along the seal surface 25 can be reduced, and as compared with the case of sliding rubber and a synthetic resin, a replacement operation of the filter element 30b can be performed easily.

As described above, in the air cleaners according to the first embodiment and the second embodiment described above, the case of forming only one seal device protection portion 34 is described, but two or more of the seal device protection portions 34, 34a and 34b may be formed. If two or more of the seal device protection portions 34, 34a and 34b are formed, the filter elements 30, 30a and 30b can be prevented from being diagonally assembled with respect to the horizontal plane along the insertion direction at the time of insertion of the filter elements 30, 30a and 30b, and the seal devices can be protected more reliably. It is obvious from the description of Claims that the modes to which such modifications or alterations are added also can be included in the technical range of the present invention.

### REFERENCE SIGNS LIST

1 air cleaner, 10 cover, 11 outlet port, 12 hinge portion, 13 latch portion, 20 case, 21 inlet port, 22 opening, 23 cutout portion, 24 hinge receiving portion, 25, 125 seal surface, 30, 30a, 30b, 130, 130′ filter element, 31 filter portion, 32 flange portion, 33, 133, 133′ seal device, 34, 34a, 34b seal device protection portion, 35,37 protruding portion, 36 extended portion, 121 guide, F insertion direction

1. An air cleaner comprising:
a housing including a case in which an opening and an inlet port are formed, and a cover that has an outlet port formed, and hermetically seals the opening, and
a filter element that partitions an inside of the housing into a dust side on a side of the inlet port, and a clean side on a side of the outlet port,
the filter element including a filter portion that filters a fluid flowing from the inlet port, and a flange portion having a seal device that hermetically seals the opening along the opening and is formed by being extended toward an outer side of the housing,
wherein the flange portion further includes a seal device protection portion extending along an extending direction of the flange portion.

2. The air cleaner according to claim 1,
wherein the seal device protection portion is extended along an insertion direction at a time of assembling the filter element to the housing.

3. The air cleaner according to claim 1,
wherein the seal device protection portion is inserted into a cutout portion formed on the case.

4. The air cleaner according to claim 3,
wherein the seal device protection portion protrudes to an outside of the case.

5. The air cleaner according to claim 1,
wherein the seal device protection portion includes a protruding portion that protrudes to a side of the case.

6. The air cleaner according to claim 1,
wherein the seal device protection portion is formed integrally with the seal device.

7. The air cleaner according to claim 1,
wherein two or more of the seal device protection portions are formed.

8. The air cleaner according to claim 2,
wherein the seal device protection portion is inserted into a cutout portion formed on the case.

9. The air cleaner according to claim 2,
wherein the seal device protection portion includes a protruding portion that protrudes to a side of the case.

10. The air cleaner according to claim 3,
wherein the seal device protection portion includes a protruding portion that protrudes to a side of the case.

11. The air cleaner according to claim 4,
wherein the seal device protection portion includes a protruding portion that protrudes to a side of the case.

12. The air cleaner according to claim 2,
wherein the seal device protection portion is formed integrally with the seal device.

13. The air cleaner according to claim 3,
wherein the seal device protection portion is formed integrally with the seal device.

14. The air cleaner according to claim 4,
wherein the seal device protection portion is formed integrally with the seal device.

15. The air cleaner according to claim 5,
wherein the seal device protection portion is formed integrally with the seal device.

16. The air cleaner according to claim 2,
wherein two or more of the seal device protection portions are formed.

17. The air cleaner according to claim 3,
wherein two or more of the seal device protection portions are formed.

18. The air cleaner according to claim 4,
wherein two or more of the seal device protection portions are formed.

19. The air cleaner according to claim 5,
wherein two or more of the seal device protection portions are formed.

20. The air cleaner according to claim 6,
wherein two or more of the seal device protection portions are formed.
